(19) United States
(12) Patent Application Publication
(10) Pub. No.: US 2007/0178012 A1
(43) Pub. Date: Aug. 2, 2007

(54) Side view imaging microwell array

(76) Inventors: Anthony A. Ferrante, Belmont, MA (US); David I. Rosen, Arlington, MA (US); R. Daniel Ferguson, Melrose, MA (US)

Correspondence Address: PROSKAUER ROSE LLP, ONE INTERNATIONAL PLACE 14TH FL, BOSTON, MA, 02110, US

(21) Appl. No.: 11/488,901

(22) Filed: Jul. 18, 2006

Related U.S. Application Data
(60) Provisional application No. 60/700,616, filed on Jul. 19, 2005.

(51) Int. Cl. G01N 21/00

(52) U.S. Cl. 422/82.05

(57) ABSTRACT

Methods and apparatus for imaging a sample using a microwell array are provided. The methods and apparatus allow side view imaging of a sample to acquire fluorescence or bright field images.

### CROSS REFERENCE TO RELATED APPLICATIONS

This application claims the benefit of U.S. Provisional Patent Application Ser. No. 60/700,616 filed on Jul. 19, 2005.

### GOVERNMENT RIGHTS

This technology was made with government support under Contract No. 1 R43 DK068887-01 awarded by the National Institute of Health. The government may have certain rights in the technology.

### FIELD OF THE INVENTION

The technology relates generally to methods and apparatus for imaging a sample using a microwell array, and more particularly to using a microwell array that allows side view imaging to acquire fluorescence or bright field images.

### BACKGROUND

Model organisms can be used for drug-discovery assays, small molecule library screening, and early stage toxicology screening applications. One such model organism, the zebrafish, offers a powerful combination of low cost, rapid in vivo analysis and complex vertebrate biology. A competitive advantage of zebrafish over other model systems includes optical clarity in a vertebrate embryo or larva amenable to large-scale screening, including genetic and small molecule compound screens. In addition, zebrafish are considered closer to humans evolutionarily than yeast, insects or worms, and experiments using zebrafish can be completed faster and with less expense than those using other vertebrate species, such as mice.

Zebrafish embryos are transparent vertebrates that develop outside the mother's body. The fish change from an egg to a well-developed embryo within 24 hours, and researchers can watch the entire process using an imaging device, such as a microscope. Zebrafish embryos develop organs that are similar to those in humans, such as the central nervous system, gastro-intestinal tract, pancreas, liver, kidneys, gall bladder, and thymus, and also develop blood vessels and a beating heart.

Many of the features zebrafish researchers study can be found laterally on the animal, and are therefore best viewed from the side. This can be complicated in, for example, an older larva with an inflated swim bladder and which is resting with its ventral surface on the bottom of a conventional microwell array. Animals can be manipulated with probes and examined manually, but the zebrafish are typically either dead or anesthetized during such observations. Popular target organs for analysis include the digestive and vascular systems, but there is currently no practical way to visualize these features of older larvae in a conventional 96-well microwell array. Confocal microscopy can be slow and expensive, and the resolution is typically lower than desired. In addition, sophisticated image deconvolution algorithms and software packages are frequently unable to provide a suitable image. A new or improved method and apparatus for obtaining side view images of certain specimens, therefore, would aid in many drug-discovery, small molecule library screening, and toxicology testing applications.

### SUMMARY OF THE INVENTION

The invention, in various embodiments, features methods and apparatus for imaging a sample using a microwell array (sometimes referred to as a microplate). In some embodiments, the system can be used to acquire an image or images from various points of view, including, but not limited to, side view images, bottom view images, and top view images. For example, the system can be used to obtain a side-view of an organism such as a zebrafish or a zebrafish larva in a well of the array. Other objects, samples, and specimens can be viewed or imaged as well.

A microwell array embodying the technology can be used in various imaging devices, including, but not limited to, microscopes. The technology can be used for improved viewing and imaging and facilitates analysis of a sample, including live biological specimens placed in a microwell. For example, the technology can be used for high throughput, optical-based, drug and toxicity screening assays using small live organisms. Side view images of such organisms (in addition to bottom views) enhance the ability to get clear, direct images of affected organs of interest without the need for more complex and time consuming 3-D image scanning and deconvolution approaches. The system can also enable higher throughput screening for drug-discovery, small molecule library screening, and toxicology testing applications.

In one embodiment, a turning optic (such as an optical surface) is located adjacent a well of a microwell array. A microscope objective placed relative to the well can receive radiation via the turning optic to form an image of the sample. The image can be a side view image obtained by a microscope objective placed or located below the turning optic adjacent to the well. The microwell array can include a plurality of wells, and the microscope objective can be used to acquire an image for each well. In various embodiments, the turning optic can be a right angle turning optic such as a right angle prism or 45 degree turning mirror. The turning optic can be a separate optic provided for each well, or can be a single optic servicing a plurality of wells (e.g., a continuous optic that runs along a row of wells). For example, in some embodiments, an optical surface is adjacent two or more wells. In some embodiments, the turning optic is an integral part of the microwell array. In some embodiments, the turning optic is formed from the substrate material of the microwell array. In some embodiments, a microwell array defines an array of rectangular wells. In some embodiments, as the depth of the well increases, the width and/or the length of the well decreases such that the well narrows. This can allow room for side viewing optics to be placed or located in between adjacent wells. In some embodiments, a third wall of the well has a turning optic adjacent thereto. In still other embodiments, a forth wall of the well has a turning optic adjacent thereto.

A feature of the technology is the implementation of a side viewing optical design that can allow for a high packing density of the wells (e.g., a 96 well microplate or a 384 well microplate) and that can preserve typical center-to-center spacing of wells used in conventional microplates. In addition, in some embodiments, standard external microplate dimensions associated with a conventional 96 well or 384 well microplate can also be preserved in a single piece microwell array or a microwell array that includes a top portion. An advantage of one or more of these features is the capability of using a microwell array embodying the technology with standard microplate handling and liquid handling robotics. For example, existing robotic instrumentation can be used for the automation of assays performed in a microwell array having 96 wells.

In some embodiments, at least one wall of the well is adapted to orient a bottom surface of the sample adjacent a bottom plane of the well. For example, where an organism such as a zebrafish is imaged, rectangular wells can be narrowed in at least one dimension. Narrowed rectangular wells provide an advantage over a conventional circular or square cross-section well. The rectangular wells can serve to orient the specimen or sample into a position that optimizes viewing. For example, the length of the sample can be oriented by the well along the long dimension of a rectangular well. Side view images of the sample can be collected via the side viewing optics placed or located along the length of the well.

In various embodiments, the microwell array is adapted to facilitate filling of a well of a microwell array. In one embodiment, the microwell array includes an optional top portion (also referred to herein as an upper portion). The optional top portion of the microwell array can include a hole positionable over a well of the microwell array. The hole can have a flared rectangular funnel shape to assist filling. The optional top portion can be removable from the microwell array, or can be integral with the microwell array.

In various embodiments, the optional upper portion can protect the optical surfaces (e.g., the prism or turning optic). This can prevent contamination of critical surfaces of the turning optic. The optional upper portion, or a portion thereof, can also act as a diffuser window. Radiation directed through a top of a well or to a turning optic can be diffused. This can facilitate uniform illumination of a well, which can be advantageous in side view bright field imaging of a specimen or a sample in a well. In some embodiments, a light source is positioned over a well and the light is diffused for fluorescence imaging.

The technology also includes manufacturing techniques for forming a microwell array. These techniques include: 1) precision injection molding techniques, as well as an injection mold tool design, and 2) other manufacturing techniques for forming and positioning small optical components along a microwell that enable side view images of a specimen in the well.

The various embodiments described herein can be complimentary and can be combined or used together in a manner understood by the skilled person in view of the teachings contained herein. Other aspects and advantages of the technology will become apparent from the following drawings and description, all of which illustrate the principles of the technology, by way of example only. The drawings are not necessarily to scale, emphasis instead generally being placed upon illustrating the principles of the technology. In some Figures, dimensions are shown. The dimensions shown are exemplary and need not be used in an array. Other dimensions can be used to form a suitable microwell array.

### BRIEF DESCRIPTION OF THE DRAWINGS

FIGS. 1A and B show an exemplary microwell array having 12 wells, and cross section view A, respectively.

FIG. 2 shows a sectional view of an embodiment of a microwell array depicted with an optional top portion that protects the turning optic and aids delivery of sample to the well.

FIG. 3 shows an embodiment of a microwell array; cross sections A, B, and C are shown in FIGS. 3B-D, respectively.

FIGS. 4A-C show cut away views of an embodiment of a microwell array and an optional upper portion.

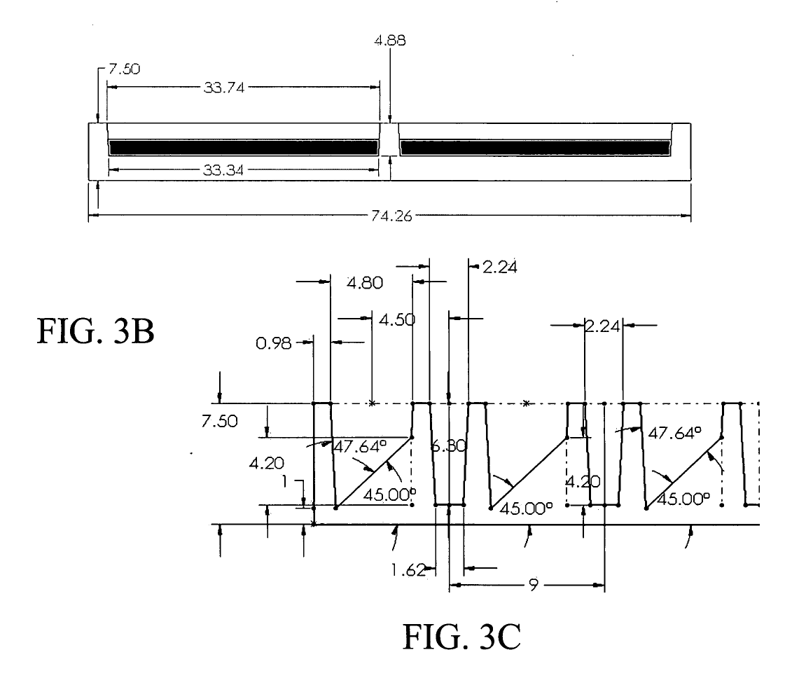

FIGS. 5A-D show an embodiment of an upper portion for a microwell array; cross sections D-F are shown in FIGS. 5B-5D, respectively.

FIG. 6 shows a view of the underside of the upper portion shown in FIGS. 5A-D.

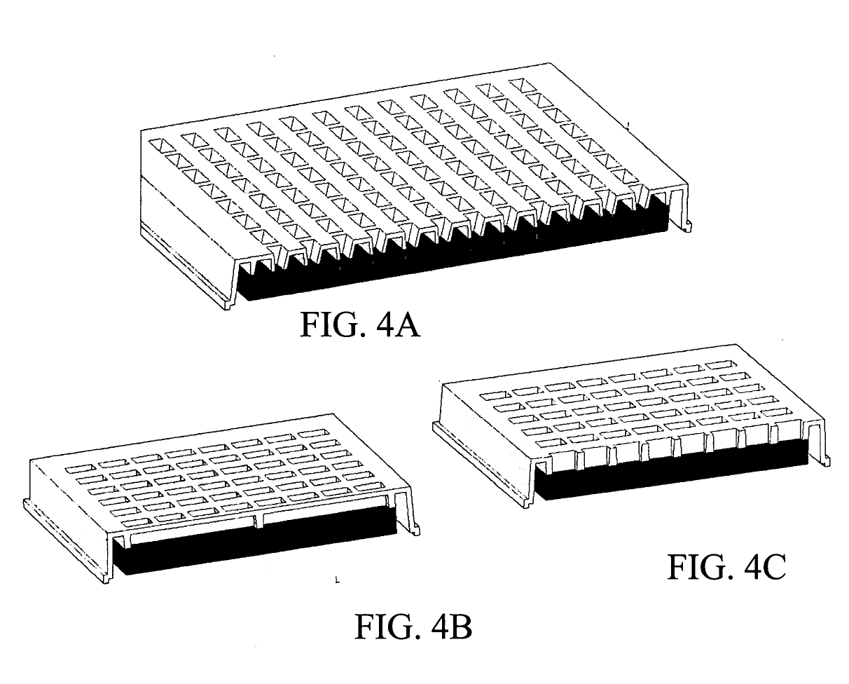

FIGS. 7A-D show cut away views of an embodiment of a side view microwell array; the underside is shown in FIG. 7D.

FIG. 8 shows an embodiment of a microwell array; FIG. 8A shows the underside and the cross sections B and C are shown in FIGS. 8B-C, respectively.

FIG. 9 shows a close up view of the cross section from circle E of FIG. 8C.

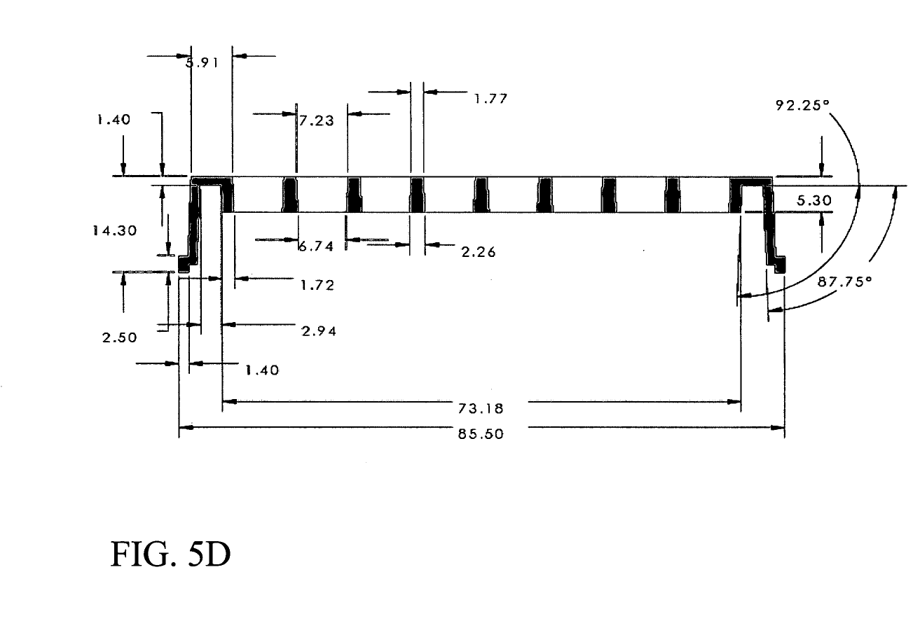

FIG. 10 shows a close up view of the cross section from circle F of FIG. 8B.

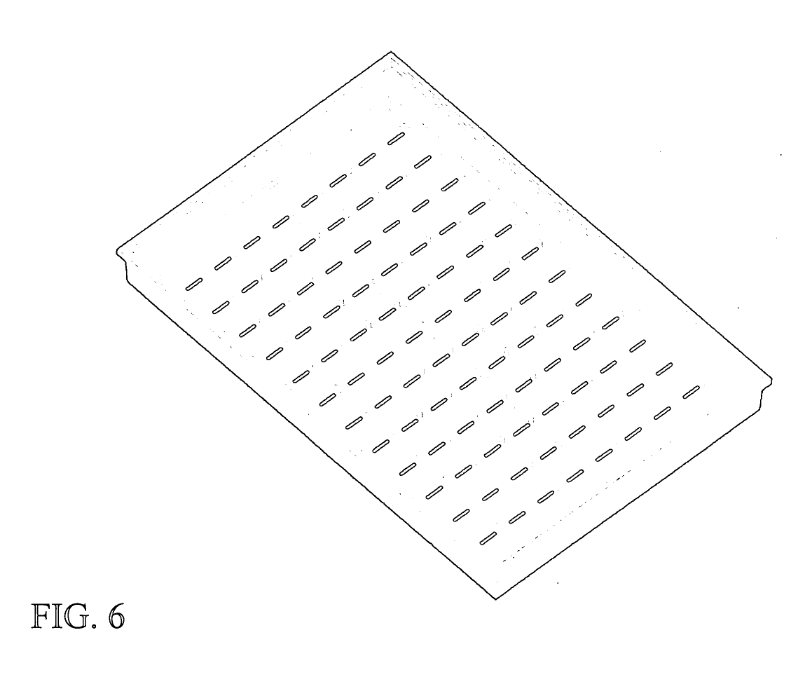

FIG. 11 shows a cross sectional view along the parting line H of FIG. 8B.

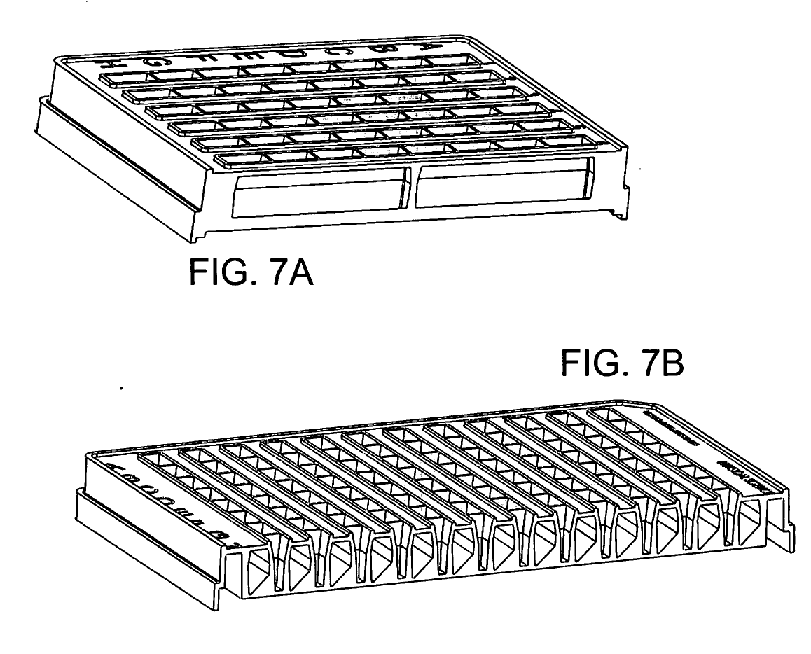

FIG. 12 shows a top view of an embodiment of a microwell array.

FIG. 13 shows another view of an embodiment of a microwell array.

FIG. 14A-C show another example of a side view microwell array, (B shows a close up view of a cut away of a corner of the microwell array along the length of the tray, and (C) shows a cut away view along the length of the tray.

FIG. 15 shows a top view (A), narrow side view (B), and wide side view (C) of an exemplary well; the location and orientation of a zebrafish larva is indicated in (C).

FIG. 16 shows an exemplary system for illuminating the side of a sample in a well and collecting reflected or emitted radiation through a turning optic.

FIGS. 17 A-B show exemplary systems for collecting transmitted light brightfield images (A) or fluorescence (B) images of a sample.

FIG. 18 shows a reflected white light image of a sample.

FIG. 19 shows a fluorescence image of the sample.

FIG. 20 shows reflected white light side view images of a sample.

FIG. 21 shows reflected white light bottom view images of a sample.

FIG. 22 shows a fluorescent side view image of a sample.

FIG. 23 shows a fluorescent bottom view image of a sample.

FIG. 24 shows a fluorescent images of stained (panels A, C, and E), and unstained (panels B, D, and F) zebrafish larvae visualized at both 2.5×(A, B, E, and F) and 5×(C and D); panels E and F are bottom view images and panels A-D are side view images.

FIG. 25 is a bar graph showing total gut fluorescence measurement was normalized by the exposure time from 20 animals treated with 1) Ped6; 2) Atorvastatin (Lipitor) 1 mg/ml and Ped6; or 3) no Ped6, no Atorvastatin.

FIGS. 26A and B show fluorescence images produced by illumination of treated (A) and untreated (B) animals obtained in a system as shown in FIG. 17B.

FIG. 27 shows a brightfield transillumination of zebrafish larvae in a side-view array obtained in a system similar to that shown in FIG. 17A.

FIGS. 28A and B show fluorescent side view images of 4 dpf (A) and 6 dpf (B) zebrafish that express green fluorescent protein (GFP) under control of the fli-1 gene.

FIGS. 29A-D show fluorescent side view images of (A) an untreated animal, (B) an animal treated with compound 676475 at 1 μM, and (C) an animal treated with compound 676480 at 10 μM, and (D) an animal treated with compound 676480 at 1 μM.

FIG. 30 shows another embodiment of a microwell array.

### DETAILED DESCRIPTION OF THE INVENTION

In one aspect, the technology features an apparatus for imaging a sample. The apparatus includes a substrate defining a well, a first wall, and an optical surface adjacent the first wall of the well. The optical surface directs radiation from the well to an imaging lens. In some embodiments, the imaging lens is located below the substrate. The apparatus can also include a second optical surface adjacent a second wall of the well. The second optical surface directs incident radiation through said second wall to the sample. For standard fluorescence with epiilumination, a single optic (e.g., a prism) can be used to receive radiation to form an image. For transillumination, one optic can be used to deliver radiation to the specimen, and another optic can be used to receive radiation to form an image.

In some embodiments, the well includes at least one wall adapted to orient a bottom surface of the sample adjacent a bottom plane of the well. In some embodiments, the incident radiation is directed to a side surface of the sample, and radiation reflected or emitted by the sample directed to the imaging lens thereby forming an image of the sample. In one embodiment, the first optical surface directs an incident beam of radiation traveling along a first optical path to a second, substantially orthogonal optical path to the sample through the wall of the well.

In some embodiments, at least one of the first and second optical surfaces or turning optics is integral with the substrate. The first or second optical surface can include, for example, a prism formed in a lower portion of the substrate. In other embodiments, the first and/or second optical surfaces can include a prism placed or attached to the microwell array such that the optical surface is adjacent a wall of the well. In still other embodiments, the turning optic can be provided separately from the microwell array. The microwell array can comprise, for example, a channel or opening adjacent one or more wells. The channel or opening is of a size and shape suitable to receive the turning optic, such that the turning optic can direct radiation from the well to a microscope objective, or from an incident light source to the side of the well. In some embodiments, the microscope objective is modified to include the turning optic.

In various embodiments, the substrate includes an optional upper portion defining a hole positionable over a top plane of a well. In some embodiments, the hole is tapered to aid in depositing sample into the well. The optional upper portion can diffuse radiation to facilitate uniform transillumination of the sample.

In yet another aspect, the technology features an apparatus for imaging a sample. The apparatus includes a substrate defining a well for holding the sample, means for directing a beam of radiation to the sample through a wall of the well, and means for receiving radiation reflected by the sample to form an image of the sample.

Imaging system modifications are provided that aid the use of side-view arrays. In one embodiment, uniform top illumination of a well for exciting fluorescence in the sample is provided. There are several advantages to this approach versus epiilumination. First, living sample, such as zebra fish larvae, exhibit a light avoidance response. Thus, if the well is unevenly illuminated, the sample will move to the shadowed areas. The 2.5× objective can provide a wide enough field of view to yield uniform illumination of the well. When using the 5× objective, however, it is necessary to anesthetize the sample to prevent it from moving out of the imaging field. Top illumination that fills the well would enable the use of higher power objectives without anesthetizing the sample. Second, a living sample, such as a zebra fish can roll onto its side in an apparent effort to avoid having the light shine directly into one eye. Top illumination would prevent this response. Third, top illumination increases fluorescence signal to background because autofluorescence of the bulk plastic of the prism would not be excited as it is with epiilumination via the prism. This is especially important for dim samples.

In another aspect, the technology features a method of imaging a sample. In some embodiments, the method comprises directing incident radiation to a sample in a well of a substrate, receiving radiation reflected or emitted by the sample through a wall of the well, and directing the reflected or emitted radiation via an optical surface formed in the substrate to an imaging lens to form an image of the sample.

In other embodiments, the method includes providing a substrate defining a well for holding the sample, the well comprising a bottom, a first wall, and a first optical surface, the first optical surface being adjacent the first wall and adapted to direct radiation from the well to an imaging lens located below the substrate. Incident radiation is directed into the well and radiation reflected or emitted by the sample is directed by the first optical surface and received into the imaging lens to form an image of the sample. In some embodiments, the method includes directing incident radiation to the sample through a wall of the well using a second optical surface adjacent a second wall of the well.

The methods can include directing the incident radiation to the optical surface using a microscope objective. In some embodiments, an optical surface directs an incident beam of radiation traveling along a first optical path to a second, substantially orthogonal optical path to the sample through the wall of the well. The methods can also include collecting radiation reflected by the sample using a microscope objective. In some embodiments, the method includes directing the incident radiation to a side surface of the sample. In various embodiments, the optical surface includes a prism formed in the substrate. The methods can include acquiring a bright field image of the sample in the well and/or acquiring a fluorescence image of the sample in the well. The method can include delivering fluorescence excitation light to the sample through the top of the well. In one embodiment, the method includes diffusing the beam of radiation to facilitate uniform transillumination of the sample in the well.

In some embodiments, the method includes facilitating introduction of the sample to the well using an optional upper portion defining a hole positionable over the well. In some embodiments, the optional upper portion defines a tapered hole.

In various embodiments of the method, the well includes at least one wall adapted to orient a bottom surface of the sample adjacent a bottom plane of the well. In various embodiments, the sample can be a zebrafish.

The sample or specimen includes any organism suitable for use in microwell assays. Suitable organisms include any animal, fish, amphibian and the like that have a developmental stage that is of a size suitable for microwell analysis. For example, the organism can be in early stages of development, such as fertilized eggs or larvae. In other embodiments, the sample can be an adult organism. Suitable organisms include various developmental stages of, for example, zebrafish (Danio rerio), Drosophila melanogaster, and Xenopus laevis. Other suitable fish include, for example, fugu (pufferfish), medaka, Giant rerio, and Paedocypris. In some embodiments, a sample can be anesthetized prior to imaging. Alginate can also be used to form a gel and prevent a sample from drifting or re-orienting during imaging.

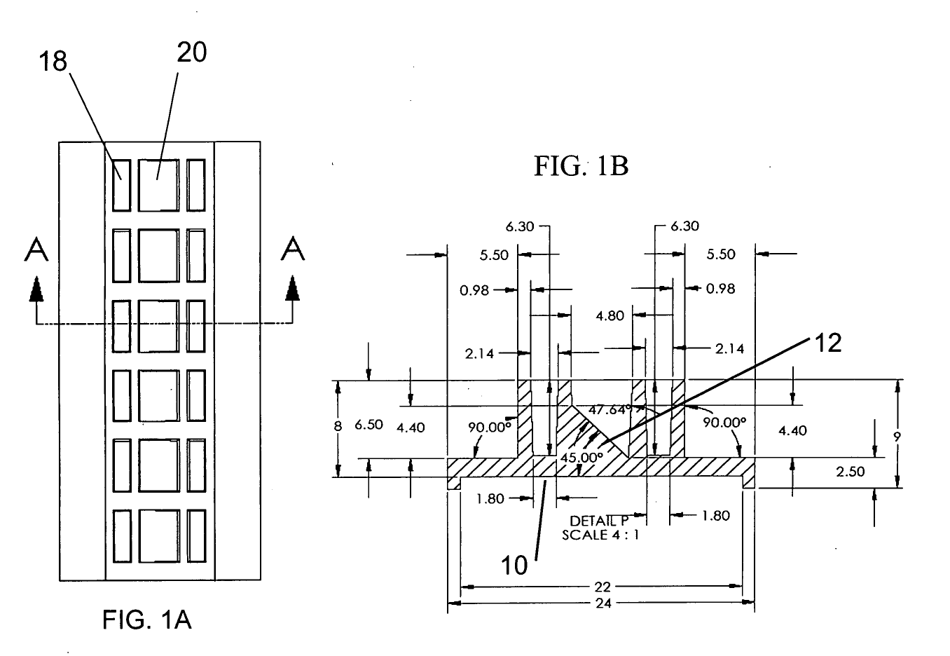

FIG. 1 shows an exemplary microwell array having 12 wells. The array can be used for side view imaging. The 12 narrow rectangles 18 indicate the positions of the wells, and the 6 larger rectangles 20 indicate the positions of optics for directing incident radiation and/or side viewing. In some embodiments, the optics are prisms. A sectional view of the array is also shown. As shown in FIG. 1B, surface 10 and/or surface 12 can be an optical grade surface finish.

In some embodiments, the microwell array can comprise any number of wells. For example, the microwell array can comprise 6, 12, 24, 48, 96, or 384 wells.

In one embodiment, the microwell array can be formed by injection molding using standard injection molding and tooling methods in the art of complex optical components. A 420-stainless steel cavity can be used. The array can be formed from an optical material including, but not limited to, plastic, glass, quartz, or fused silica. Suitable plastics include acrylic, polystyrene, polycarbonate (standard or optical quality) Zeonor, Zeonex and TOPAS COC (Ticona). The bottom surface of the array and the surface of the optics can be polished to an optical quality. For example, the bottom surface and the optics can have a mirror-like surface polish, a surface cosmetic quality and a surface figure accuracy that are customary for optical devices. In one embodiment, one or more walls of the wells are tapered to allow release of the microwell array from a mold being used to form the array. In some embodiments, substrate forms the walls of the wells and the optical surfaces.

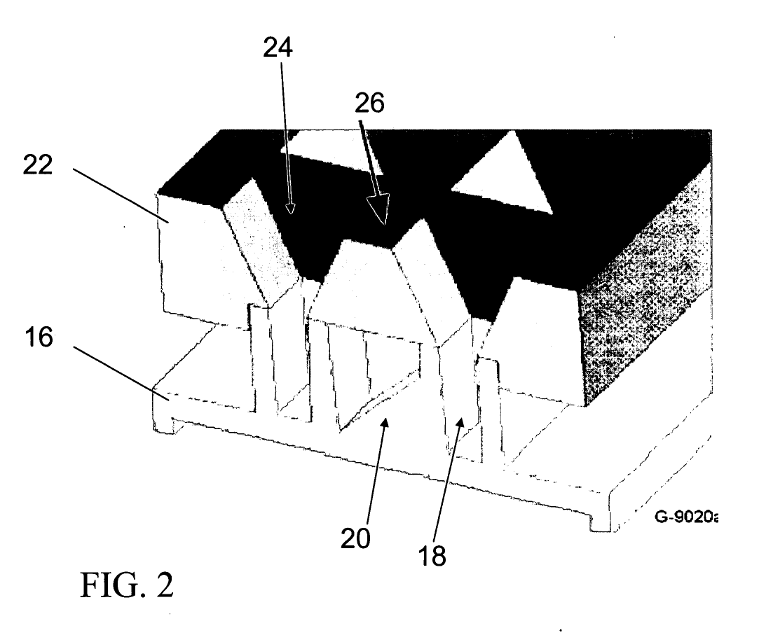

FIG. 2 shows a sectional view of an exemplary embodiment of a microwell array including a substrate 16 defining a plurality of wells 18. An optic 20 for directing radiation to one or more wells is formed in the substrate. The array shown in FIG. 2 includes an optional second component 22, also referred to herein as upper portion. The upper portion can be a separate piece or can be formed from the substrate material. In one embodiment, the substrate and the upper portion can be formed as two pieces, and the upper portion can be positioned in contact or in close proximity to the substrate. The upper portion can be aligned with the substrate using alignment features, such as pins. The upper portion can be affixed to the substrate, for example using a glue, an epoxy, ultrasonic welding, a snap fit, or other suitable attachment means. In one embodiment, the upper portion and the substrate are attached so that they form one piece. The second component and the substrate can be formed from the same material, or can be formed from two distinct materials. Suitable materials for the second component include, but are not limited to, plastic, glass, quartz, and fused silica.

The optional second component can define a plurality of holes 24 that can facilitate introduction of a sample into a well. The hole can have a tapered cross section. For example, the hole can act as a funnel to direct a specimen, e.g., an animal-containing droplet, toward or into a well. The second component can also act as a baffle 26 to prevent or mitigate stray light from entering a collection optic. The second component can be formed from a colored material or can be colored after formation. In one embodiment, the second component can be dyed black after manufacture so that it acts as a light baffle. The second component can provide protection for the optic used to direct radiation to a well. For example, the second component can keep an optical surface free, or substantially free, of a contaminant, e.g., moisture, solvents, debris, and/or dust. A contaminant can interfere with redirection of a beam of radiation, e.g., total internal reflection of an optical surface or prism.

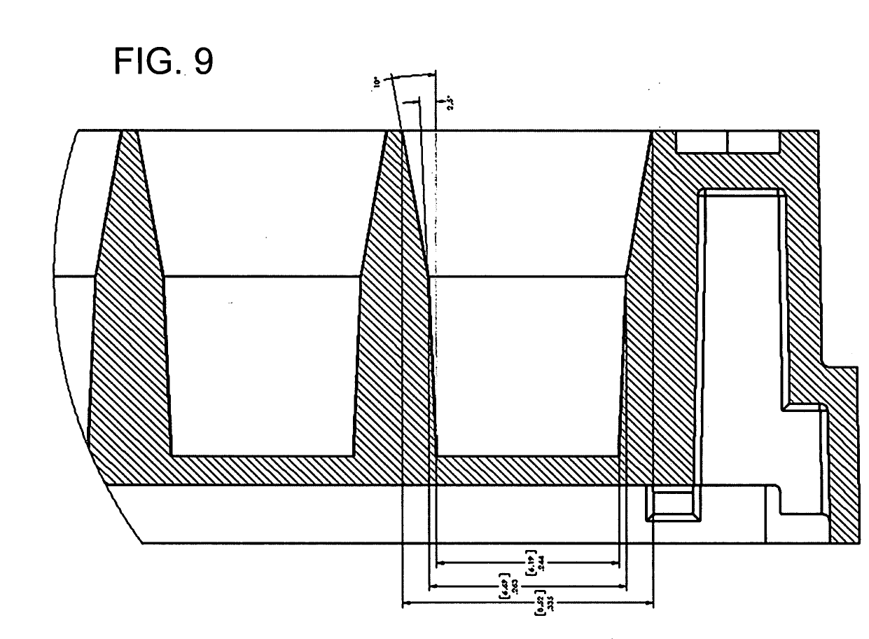

The microwell plate can be of various lengths, widths, and heights. In some embodiments, the microwell array together with the optional second component preserves standard external microplate dimensions. In other embodiments, the microplate array comprises a single piece. Single piece microplate arrays are provided that preserve standard external microplate dimensions. One example of a single piece microwell array is shown in FIGS. 14A-C.

Standard microwell dimensions are well known in the art and include, for example standards provided by the American National Standards Institute (ANSI) and the Society for Biomolecular Screening (SBS) such as ANS1/SBS 1-2004, ANS1/SBS 2-2004, ANS1/SBS 3-2004, ANS1/SBS 4-2004, and SBS5. The published standards are available on the World Wide Web at sbsonline.org/msdc/aprroved.php. In some embodiments, the microwell tray has length of about 127 mm, and a width of about 85 mm. In some embodiments, the microwell tray has length of about 127 mm, a width of about 85 mm, and a height of about 14 mm. In other embodiments, the mircrowell array has a height of about 28 mm.

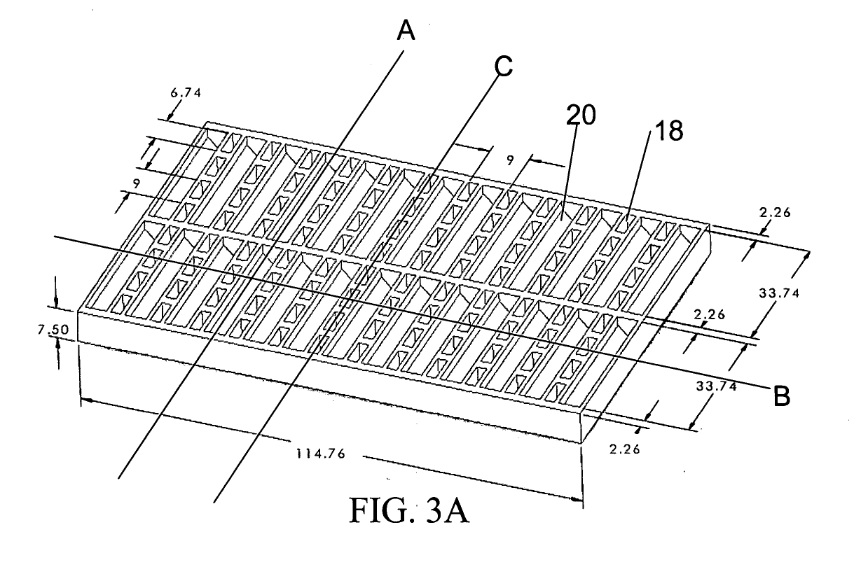

FIG. 3A shows another exemplary embodiment of a microwell array. The substrate defines a plurality of wells 18, and includes a plurality of optics 20 formed in the substrate. Sections A, B, and C of FIG. 3A are shown in more detail in FIGS. 3B-D, respectively. As shown in FIG. 3A, a single optic can be used to direct radiation to one or more wells. For example, an optical surface, such as a prism, can be formed in the substrate, and a face of the prism can be adjacent a plurality of wells. For example, the embodiment shown in FIG. 3A includes 96 wells, and a face of each prism is adjacent 4 wells. Other prism to well ratios can also be used. The dimensions shown are exemplary and need not be used in an array. Other dimensions can be used to form a suitable microwell array.

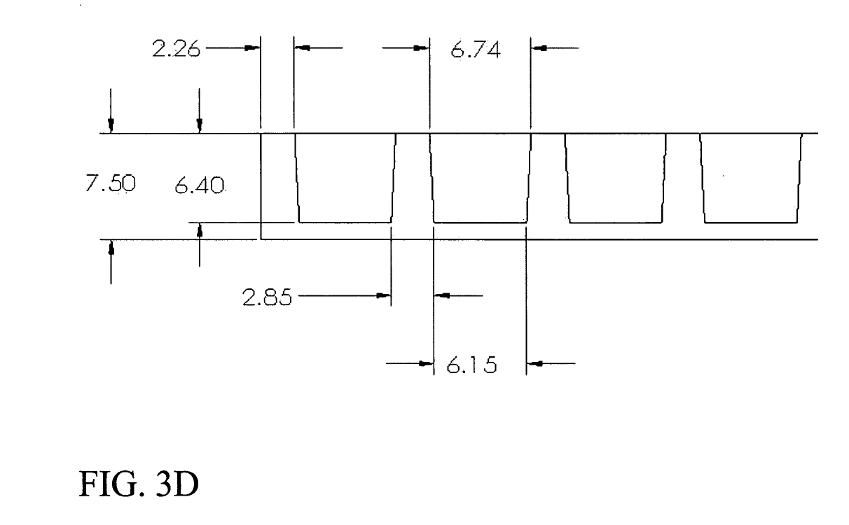

FIG. 5A shows an exemplary embodiment of an optional upper portion for a microwell array. The optional upper portion defines a plurality of holes 24, and can be used, for example, with the microwell array shown in FIG. 3A. The optional upper portion can be positioned over a microwell array such that one or more holes is positioned over a well. Sections D, E, and F of FIG. 5A are shown in more detail in FIGS. 5B-D, respectively. The tapered shape of the holes can be seen in FIG. 5B.

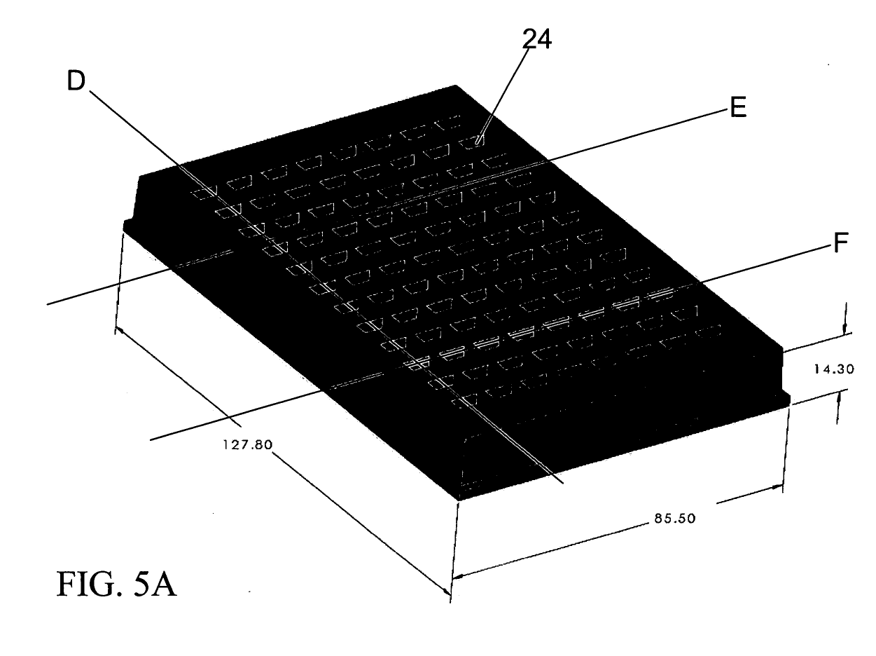

FIGS. 7A-D show cut away views of an embodiment of the microwell array with an optional upper portion. FIG. 7D shows a cut away view of the underside of the microwell array with the optional upper portion.

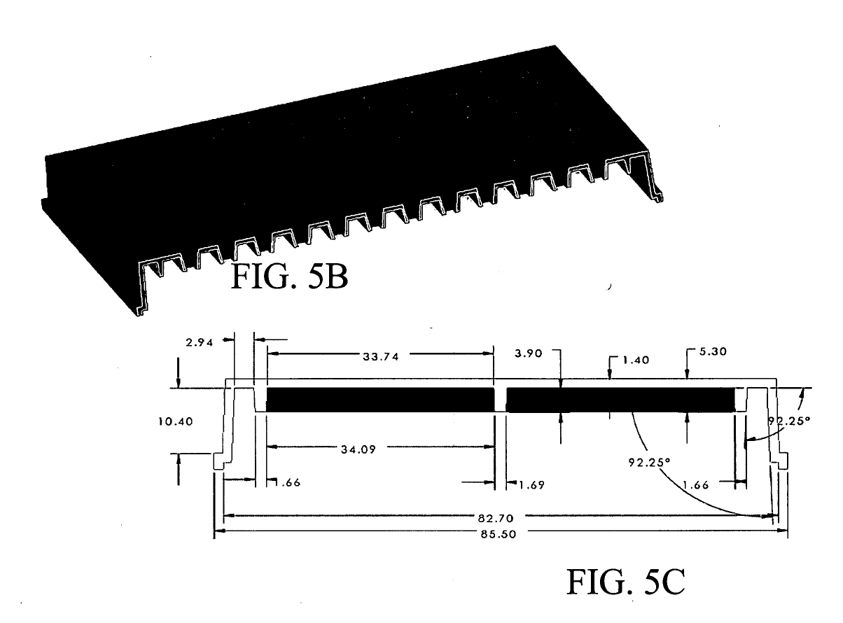

FIGS. 8A-D show additional views of an embodiment of the microwell array and optional second component. As described above, the second component and the microwell array can be formed from the same substrate, or be formed as distinct pieces. In one embodiment, the two pieces are joined, either permanently or such that they are separable. FIG. 8A shows the underside of the microwell array. Cut away views C and D are shown in FIGS. 8B and C, respectively.

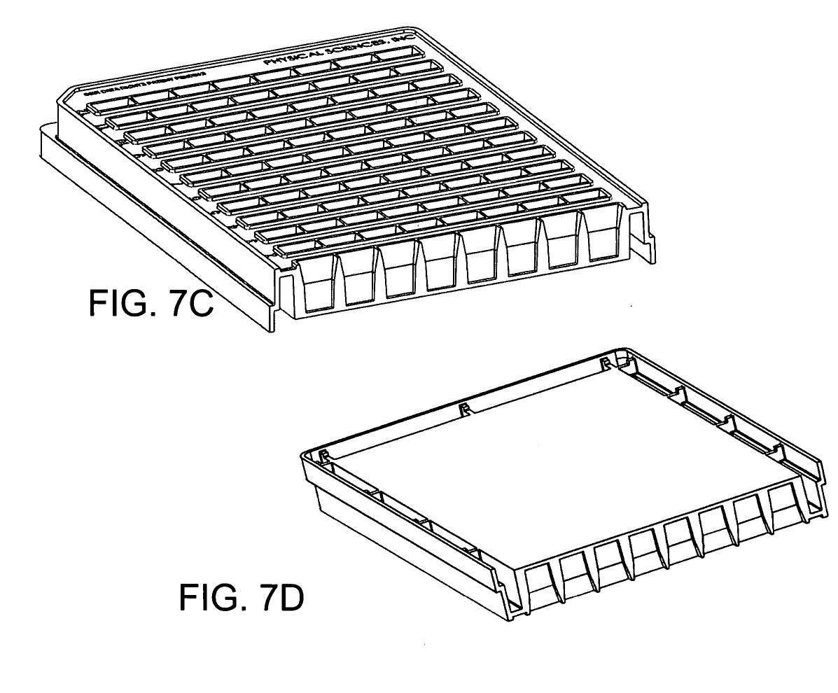

FIG. 12 shows the top view of an embodiment of an upper portion of a microwell array. As shown in FIG. 12, the typical center-to-center spacing of wells used in conventional 96 well microplates is maintained. However, the dimensions shown are exemplary and need not be used in an array. Other dimensions can be used to form a suitable microwell array.

FIGS. 14A-C show and embodiment of a microwell array that does not include the optional second component. The microwell array of FIG. 14 can be made as a single piece. As shown in FIG. 14B, the optical surfaces are open or exposed. The microwell array can be used with an optional cover, for example to protect the optical surfaces from debris. As shown in FIGS. 14B and C, the wells can be tapered from top to bottom.

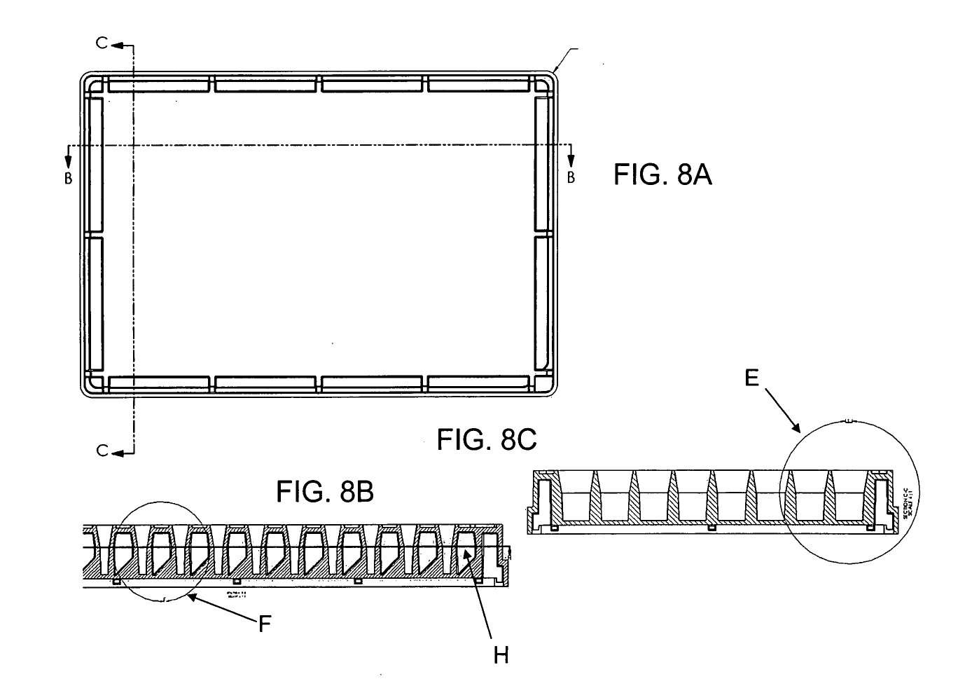

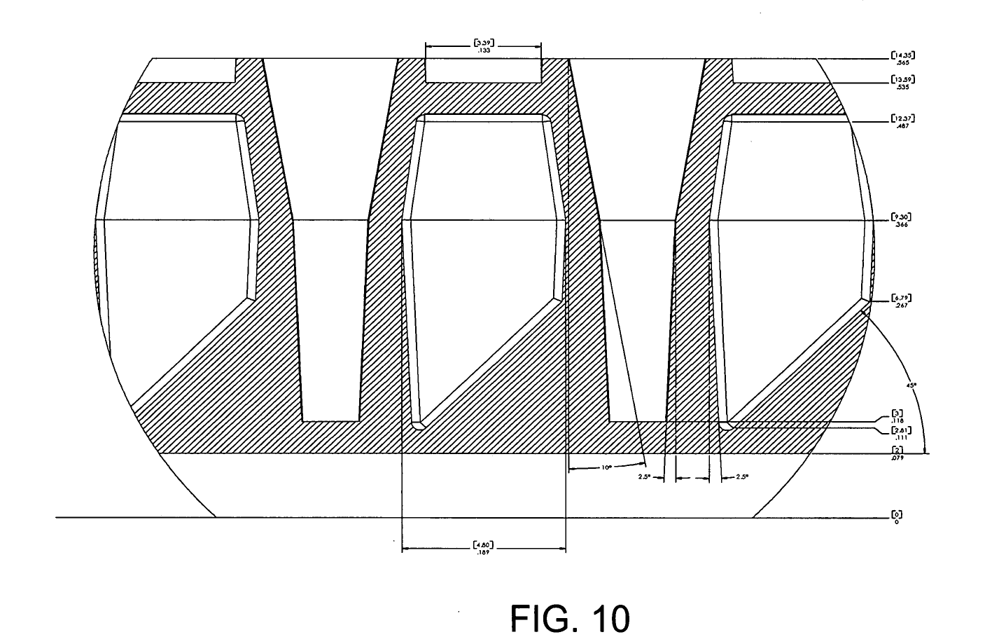

FIG. 15 shows a top view (A), narrow side view (B), and wide side view (C) of an exemplary well. As shown in FIG. 13, the well can have a rectangular shape. In some embodiments, the shape can restrict the orientation of a sample, such as a zebrafish. For example, a well can have a width of about 1.5 mm and a length of about 6 mm, at the bottom of the well. As shown in FIG. 13B, a microscope objective 36 can be located under an optical surface 12 that is adjacent to the well. A zebrafish that is longer than the width of the well can be positioned such that its side is oriented along the length of the well and its bottom surface is oriented along a bottom plane of the well.

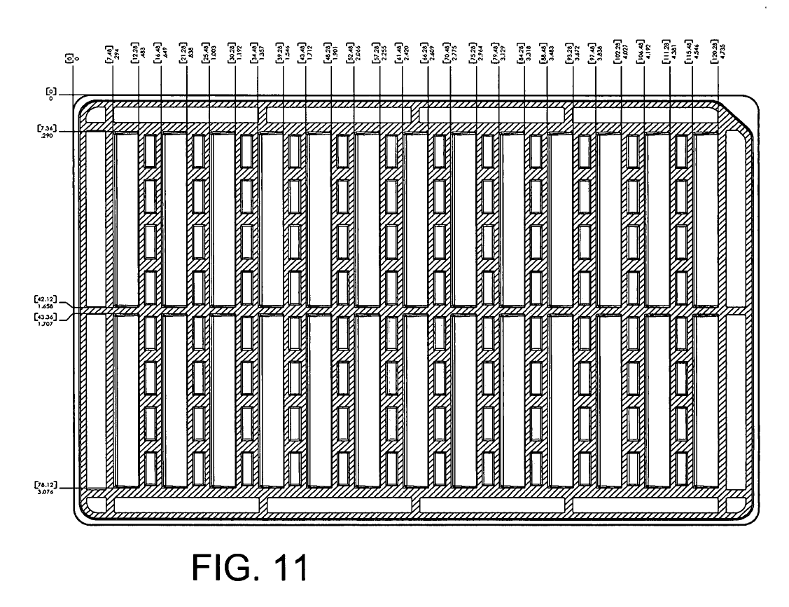

FIG. 16 shows an exemplary system for collecting radiation from a well through a bottom surface. Incident radiation 50 is introduced into the well via an optical surface 12. The radiation from the well 52 is directed by the optical surface 12 through the bottom of the microwell array.

As used herein, radiation includes any radiation suitable for forming an image of a sample. The radiation can be, for example, electromagnetic radiation. The electromagnetic radiation can be visible light or electromagnetic radiation of a wavelength suitable to illuminate or excite the sample or label within the sample. Such labels include, for example, fluorescent compounds.

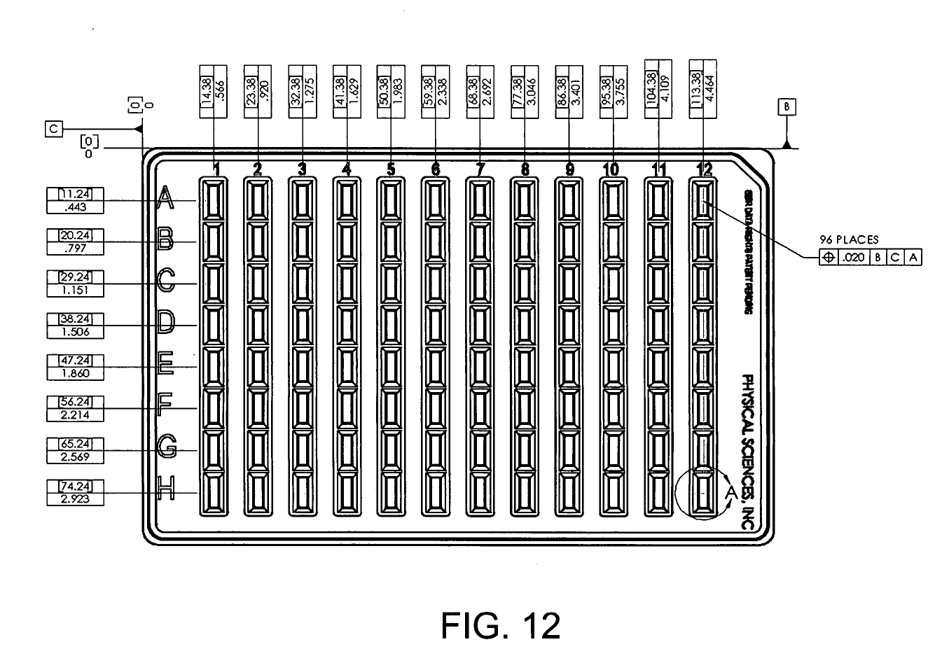

FIG. 17A shows an exemplary system for imaging a sample through the bottom of the microwell array using transillumination. In one embodiment, this method of delivering light can be used for bright field imaging. Radiation (for example, light) is introduced to the microwell array and directed by turning optic 12 (for example, an optical surface or a prism) through the well 18. Another turning optic 38 directs light from the well to a microscope objective 36, located below the microwell array and which can collect the radiation. The light from the well can be, for example, light reflected by the sample, light emitted by the sample, or light transmitted through the sample. The objective can direct the light from the well to a detector. In various embodiments, the detector is a cooled CCD. Delivery of the light is offset from the well, and, if a cover or upper portion is used, is transmitted through the cover or upper portion.

FIG. 17B shows an exemplary system for introducing radiation through the top of a well. In one embodiment, the sample fluoresces after irradiation, and the emitted radiation is directed by a turning optic 38 (for example, an optical surface or a prism) to a microscope objective 36, which can direct the radiation to a detector. The fluorescence excitation can be delivered to the sample through the top of the well (rather than through the microscope objective) to reduce autofluorescence background from the substrate material. In some embodiments, the optical surfaces reflect about 5% of the radiation.

As shown in FIGS. 17A and 17B, in some embodiments, light is introduced using an optical fiber 30. In some embodiments, the light is collimated using a collimating lens 32. In still other embodiments, a diffuser 34 is used to diffuse the radiation, for example to produce even illumination of the well.

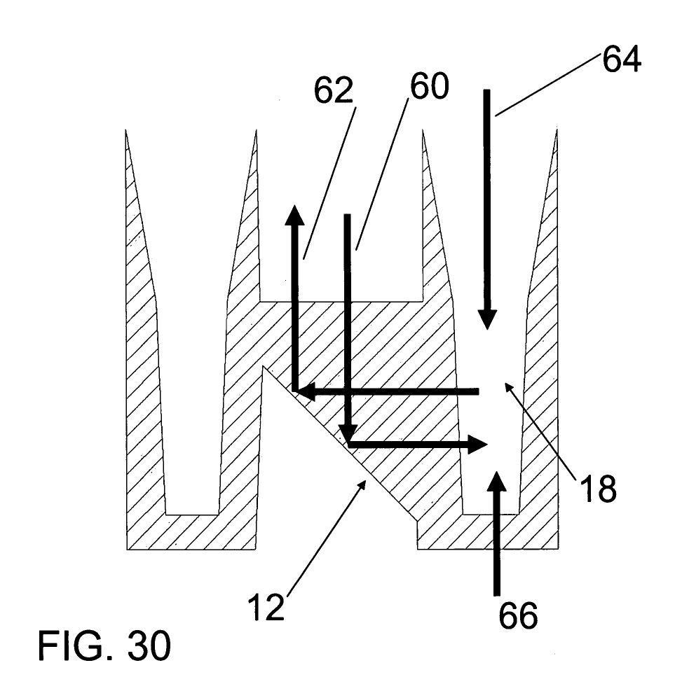

In other embodiments, a microwell array is provided that allows the collection of images from the top of the microwell array, using for example, a conventional microscope. FIG. 30 shows an exemplary system for imaging a sample through the top of the microwell array. In one embodiment, this method of delivering light can be used for bright field imaging. Radiation 60 (for example, light) is introduced to the microwell array and directed by a turning optic 12 (for example, an optical surface, or a prism) through the well 18. The optical surface 12 directs light from the well 62 to a microscope objective, located above the microwell array and which can collect the radiation to form and image of the sample. The light from the well can be, for example, light reflected by the sample or light emitted by the sample. In another embodiment, radiation 64 is introduced through the top of the well or through the bottom of the well 66. The optical surface 38 directs light 62 from the well to a microscope objective located above the microwell array. The light from the well can be, for example, light reflected by the sample, light emitted by the sample, or light transmitted through the sample. The objective can direct the light from the well to a detector. In various embodiments, the detector is a cooled CCD. Delivery of the light is offset from the well. In some embodiments, the microwell array of FIG. 30 is made as a single piece.

In some embodiments, the well is uniformly illuminated by passing the incident radiation through a diffuser. The diffuser can be provided separately. In one embodiment, a portion of the optional second component can be used to diffuse radiation to uniformly or substantially uniformly illuminate the well. In various embodiments, a microscope condenser system can include a programmable offset so that the illumination source (e.g., a fluorescence excitation source) can be positioned over the well for imaging through both the well bottom and via an optical surface. In one embodiment, illumination for fluorescence passes through a hole in the cover or the second component, which is offset from the objective when forming an image through the optical surface or prism.

An exemplary microscope can have one or more of the following features.
Scanning with 1×, 5× or 10× objectives
2.5× objective with n.a. about 0.07.
5× objective with n.a. about 0.15.
GFP bandpass filter.
Excitation wavelength of between about 450 nm to about 490 mn.
Emission wavelength of between about 500 nm to about 530 nm.
Detector, e.g., a CCD camera or a Cooke Camera having 1376×1040 pixels.
Binning capability, e.g., 2×2 binning.
Brightfield images can be generated using an immuno gold staining filter cube from Chroma, and the sample can be illuminated with a mercury lamp.
100 W mercury vapor lamp.
An automated stage, autofocus feature and a motorized turret with a variety of objectives.
Motorized filter changer for imaging at multiple wavelengths.
Collection of bright field images in about 1 ms to about 10 ms, although longer or shorter times can be used depending on the application.
Exposure times in the range of about 50 ms to several seconds, although longer or shorter times can be used depending on the application. In one embodiment, the exposure time is between about 90 ms and about 800 ms.
Use of an intensified camera can decrease the amount of exposure time required.

In one embodiment, the microscope is an inverted, microscope (e.g., a modular Leica DM IRB microscope available from Leica Microsystems (Wetzlar, Germany)). In one embodiment, the microscope is a high content screening system (e.g., a Discovery-1 Automated Microscope available from Molecular Devices Corporation (Sunnyvale, Calif.)).

As a result of the technology provided herein, zebrafish can be used in combination with the side-view imaging technology to screen uncharacterized compounds for drug discovery and testing. Images can be collected through the microwell prisms and animals identified, for example, in which the vasculature was not properly formed after treatment with the compound. Such compounds would be presumptive angiogenesis inhibitors.

### EXAMPLES

### Example 1

### Imaging Fluorescent Particles

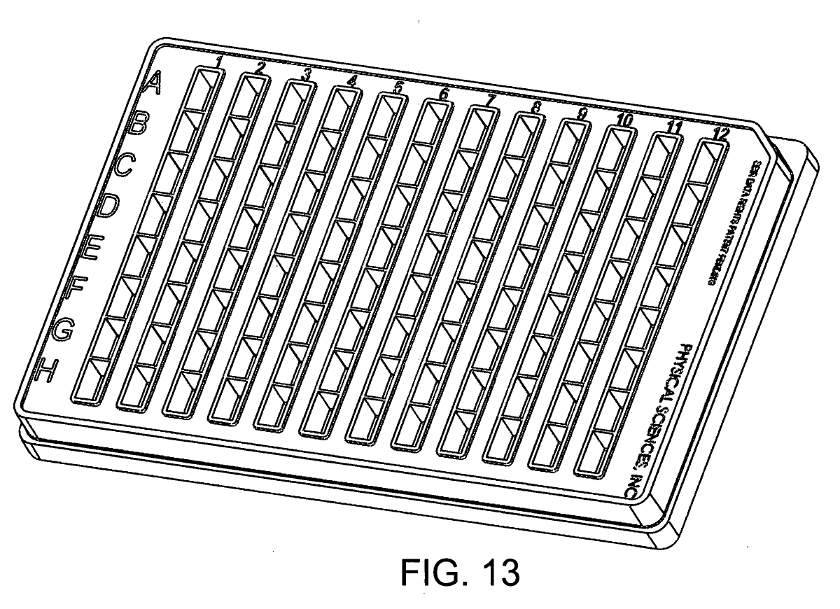

FIG. 18 shows a reflected white light image of a sample—90 μm fluorescent particles and a piece of 250 μm tubing glued to a plastic tab using optical-grade epoxy. The sample was illuminated from the top of the array using a white light source connected to an optical fiber. The radiation was collected by a microscope objective, and the radiation was directed to the objective by a polycarbonate prism formed in a 12-well array. When looking through the prisms, the light from the optical fiber was offset from the well.

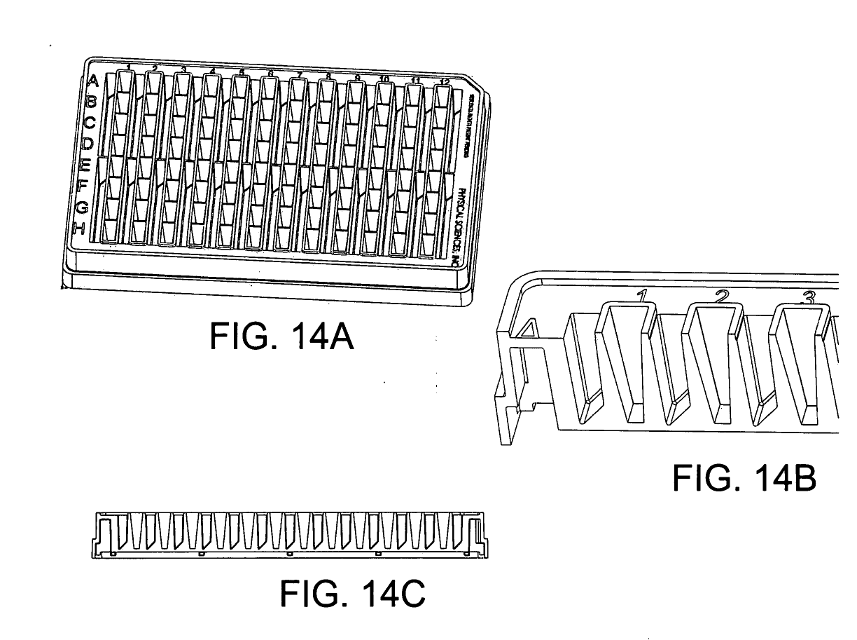

FIG. 19 shows a fluorescence images of the sample—90 μm fluorescent particles and a piece of 250 μm tubing glued to a plastic tab using optical-grade epoxy. The sample was illuminated with 450-490 nm light delivered through a 2.5× objective.

### Example 2

### Imaging Fixed Zebra Fish

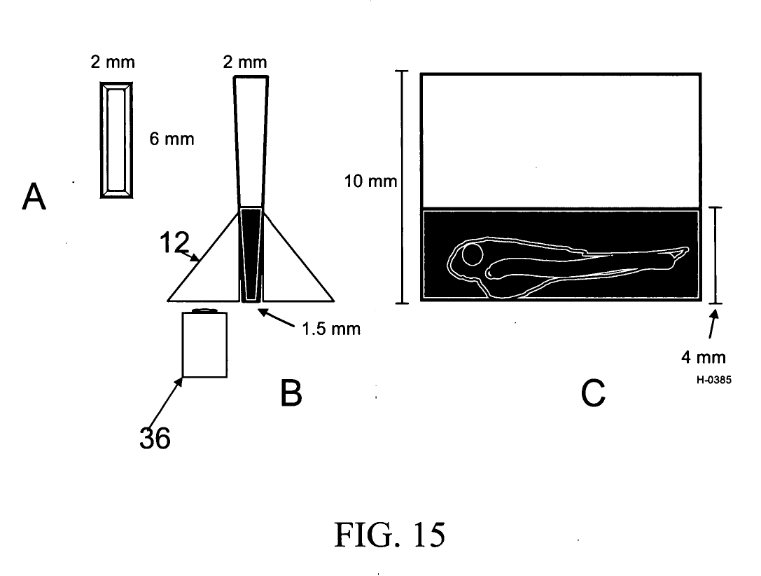

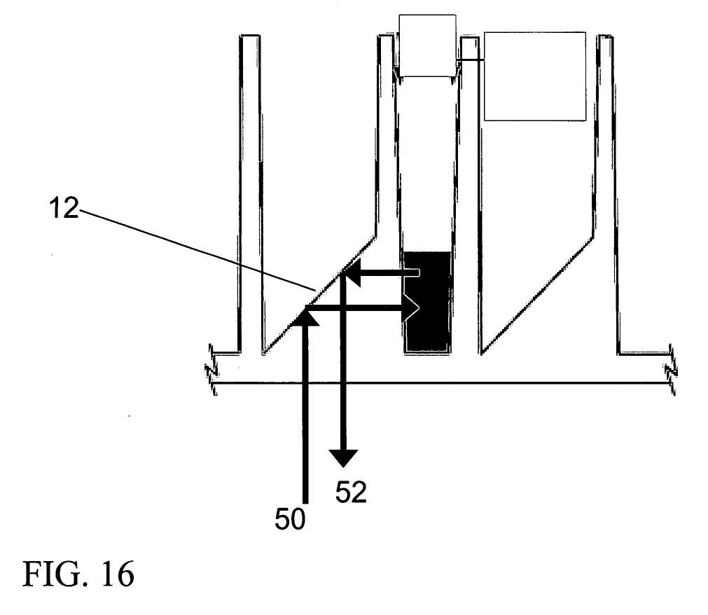

FIGS. 20 and 21 show reflected white light images of a sample—a methanol/DMSO-fixed, 5 day old zebrafish larvae embedded in 0.5% low gelling temperature agarose. FIG. 20 shows a side view obtained using a polycarbonate prism formed in a 12-well array. FIG. 21 was collected through the bottom of the well. FIG. 20 illustrates an advantage of the technology, in that organ systems aligned along the ventral to dorsal surfaces of the zebrafish can be imaged, whereas little, if any, useful information can be extracted from the image taken through the bottom of the well.

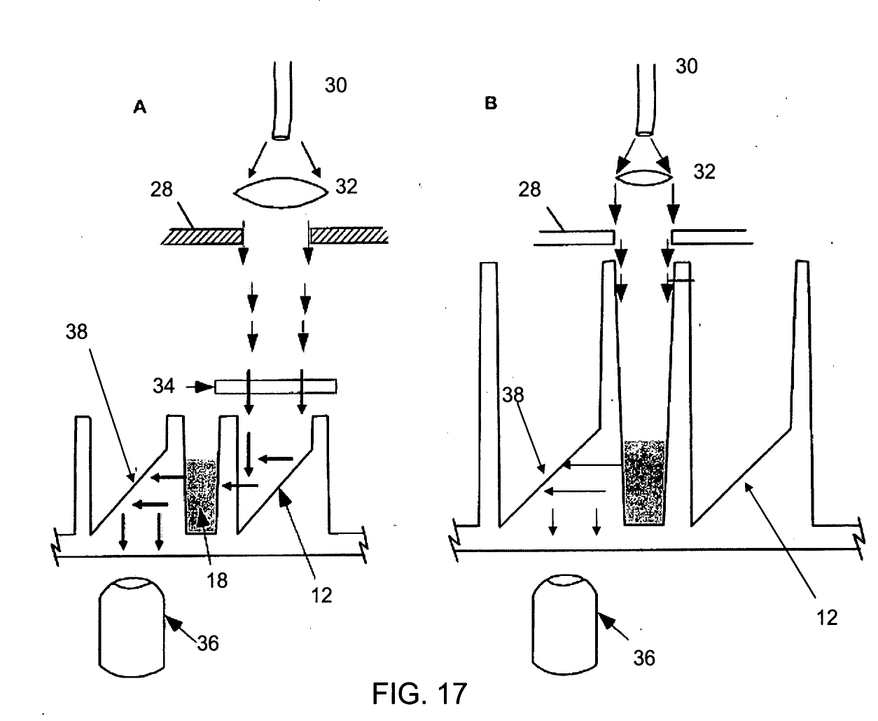

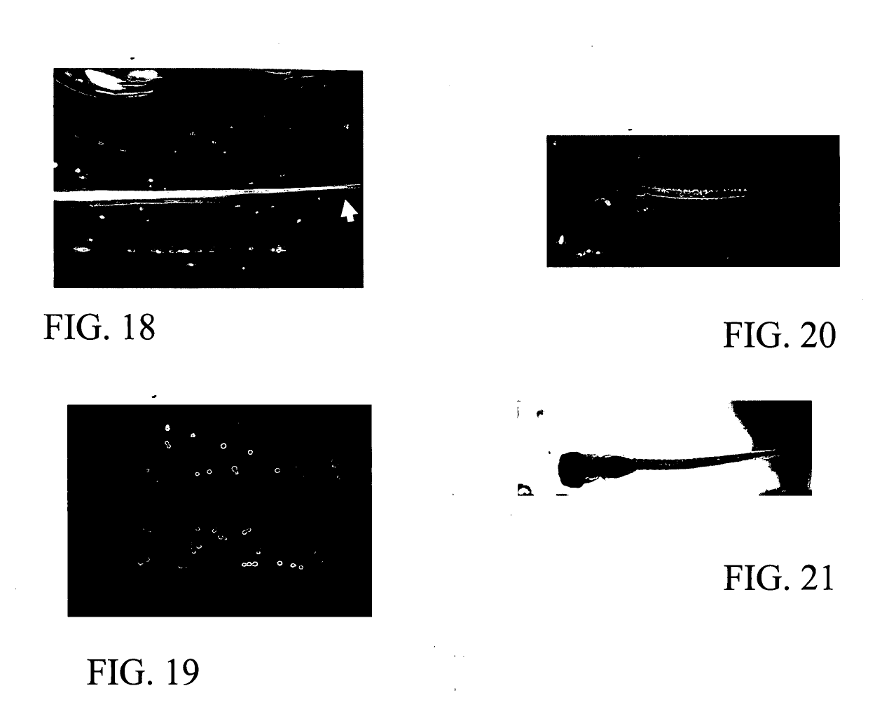

FIGS. 22 and 23 show fluorescence images of a sample. More particularly, the figures show side and bottom view fluorescence images of a zebrafish larva imaged, respectively, through a side view prism and the bottom of a rectangular well. The zebrafish was genetically engineered to express a fluorescent protein (GFP) in its vasculature.

### Example 3

### Side-view imaging

The feasibility of using side-view microarrays for collecting high-quality fluorescence images of zebrafish larvae is described. Wild-type animals were stained with the fluorogenic substrate, Ped6 [N-((6-(2,4-dinitro-phenyl)amino)hexanoyl)-1-palmitoyl-2-BODIPY-FL-pentanoyl-sn-glycero-3-phosphoetha)](Molecular Probes). Ped6 is an internally-quenched reporter for phospholipase A₂ (PLA₂) enzymatic activity. Ped6 incorporates a fluorophore and a quencher molecule which are attached to a phospholipid backbone. Upon cleavage, the fluorophore-containing moiety is absorbed by the small intestine and passes through the liver to the gall bladder where it accumulates prior to release into the intestinal lumen.

All images were generated using a Leica DM IRB inverted fluorescence microscope. Two long-working distance objectives were used: a 2.5× objective with a numerical aperture (NA) of 0.07 and a 5× objective with a NA of 0.15. In addition to their long-working distances, these objectives provided good depth of field which is useful when viewing relatively thick specimen, such as an animal that is 0.5 mm at its thickest point. Epiillumination was provided by a 100 W mercury lamp. A GFP bandpass filter cube was used for fluorescence image collection. The GFP bandpass filter cube transmitted light between 450- and 490-nm to the samples and collected light between 500- and 530-nm. Images were recorded using a Cooke Sensicam QE cooled CCD camera with resolution of 1376×1040 pixels. For the Ped6 assay, a 2×2 binning was used to speed image acquisition times.

The Ped6 assay requires the use of larvae with an active metabolism. Therefore, larvae that were a minimum of 7 days post fertilization (dpf) were used. Larvae were stained by addition of Ped6 to a final concentration of 0.3 μg/ml. Animals were loaded into wells after addition of the Ped6 and images were collected between 1 and 8 hours post-treatment.

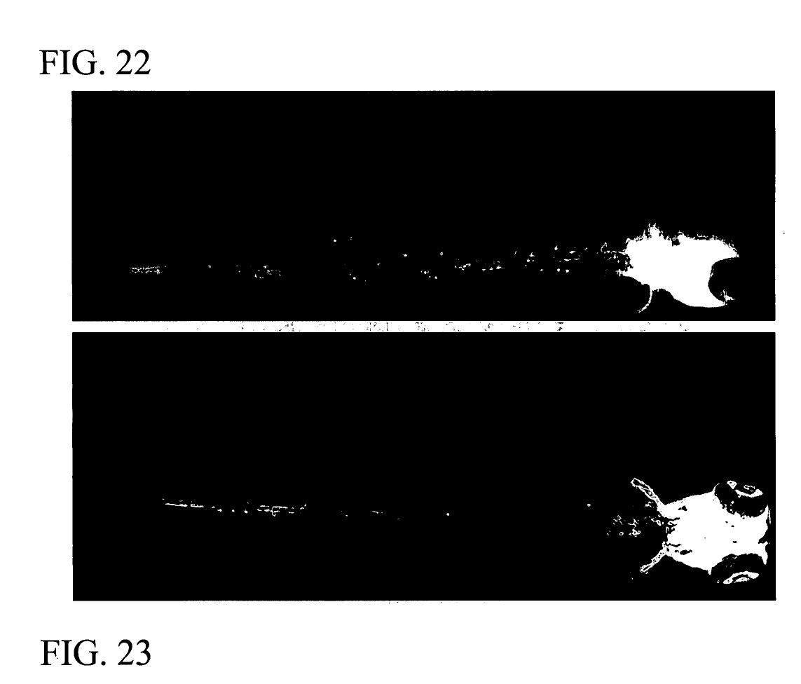

Images of unanesthetized animals were collected using epiilumination and the 2.5× objective (FIGS. 24(A, B, E, and F)) or the 5× objective (FIGS. 24(C, D). The gall bladder and intestinal fluorescence were clearly resolved. Comparison of the images shown in FIGS. 24(A) and (E) demonstrate the advantage of the side-viewing microarrays. The side-views collected through the prism (FIGS. 24A and C) clearly resolve the gall bladder and gut fluorescence. Fluorescence from those organs is not resolved when the animal is viewed from the bottom (FIG. 24E). In fact, it is difficult to distinguish the fluorescence of the stained animal from the autofluorescence of the unstained animal (FIG. 24F).

A 4- to 6-fold difference in intensity in gut and gall bladder fluorescence was measured using the 2.5× objective. The images were analyzed using Image J (open source software) using the following protocol. A background region near the gut, typically along the trunk of the animal, was defined and the mean intensity was obtained. A region was drawn around the gut and the mean background was subtracted from that area. A histogram of gut fluorescence was obtained and the total fluorescence was calculated by multiplying the mean background corrected intensity by the total number of pixels in the region.

### Example 4

### Ped6 Assay

A larger screen was performed to provide some measure of reproducibility. Twenty animals each were subjected to 3 different treatments: 1) Ped6; 2) Atorvastatin (Lipitor) 1 mg/ml and Ped6; and 3) no Ped6, no Atorvastatin. In this experiment the exposure time varied depending on the brightness of the sample. The total gut fluorescence measurement was normalized by the exposure time to enable comparison of the data.

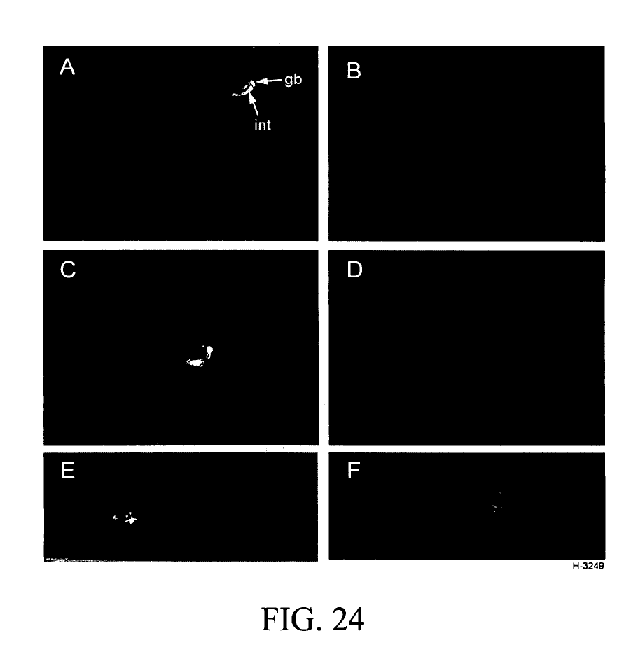

The background subtraction that was applied to the samples increased the calculated difference in intensities between the Ped6-treated and untreated samples from 4-6 fold to more than 30-fold. Mean gut fluorescence intensity for animals in each of the treatment groups are shown in FIG. 25. Addition of atorvastatin to the animals decreased the staining intensity 2-fold.

Treatment of the animals with atorvastatin resulted in a 50% reduction in the mean fluorescence intensity of the gut. The atorvastatin-treated animal with the lowest fluorescence intensity still had a signal level that was 1.7-fold higher than that of the unstained animal with the highest signal level. The atorvastatin was added less than 1 hour before the addition of Ped6. A longer pretreatment time may be required for full inhibition of PED6 processing.

### Example 5

### Optional Hardware Modifications for Optimization of Side-View

FIG. 17B is a schematic showing fluorescence transillumination of zebrafish larvae in side-view arrays. Experiments were performed using the setup schematically shown in FIG. 17B. Light from a 25 mW, 473 nm, diode-pumped, solid-state (DPSS) laser was fiber optically coupled to a collimating lens. The light passed through an aperture to avoid illuminating the bulk prism material. An optional light diffuser optic can be placed between the collimating lens and the aperture in the mask 10 to provide more uniform illumination. In some embodiments, an optional second component is used and the hole defined by the second component corresponds to the aperture and the second component is adapted to serve as a mask).

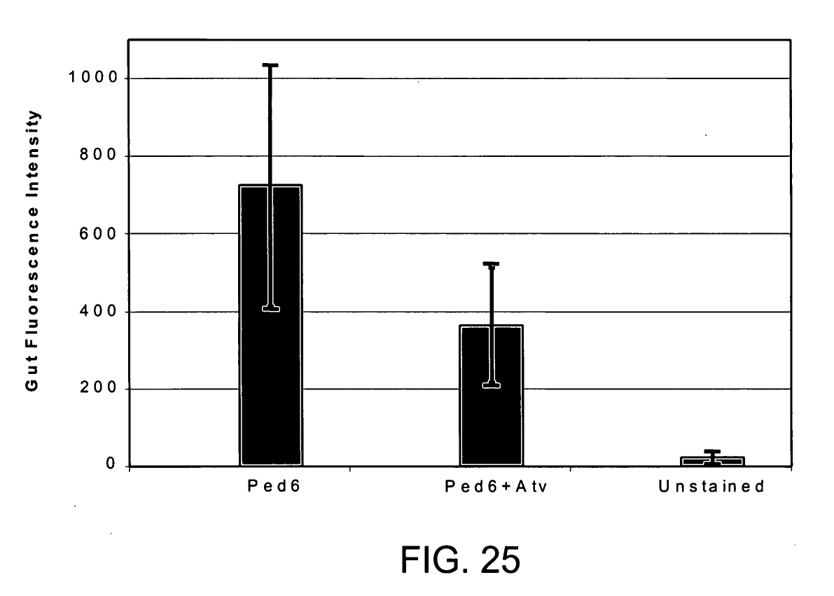

The reduction in background fluorescence using the setup of FIG. 17B was assessed. The signal from the body of an unstained animal was compared to the fluorescence background in the well adjacent to the body. The measurements showed a 3.6-fold improvement in signal to background fluorescence in the trunk of Ped6-treated animals. An example of a transilluminated, treated and untreated animal is shown in FIGS. 26A and 26B, respectively.

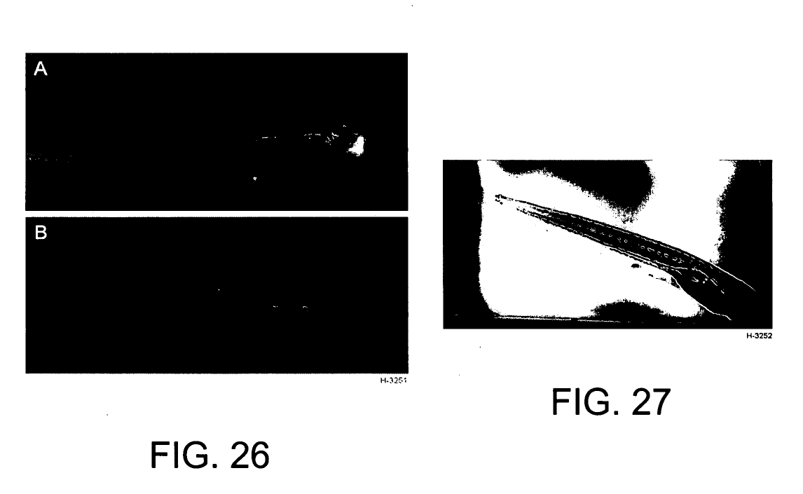

FIG. 17A is a schematic showing brightfield transillumination of zebrafish larvae in side-view arrays. As shown in FIG. 17A, a white light Xenon source is coupled to the fiber. As shown in FIG. 17A, brightfield imaging of the larvae is improved by providing true transillumination of the sample. The layout of the side view arrays advantageously allows light to reflect off of the upper surface of one prism, through the sample, and collection of the image through the imaging prism. Images collected using this approach (see FIG. 27) were of the same quality as images collected using the standard microscope condenser.

### Example 6

### Angiogenesis Assay

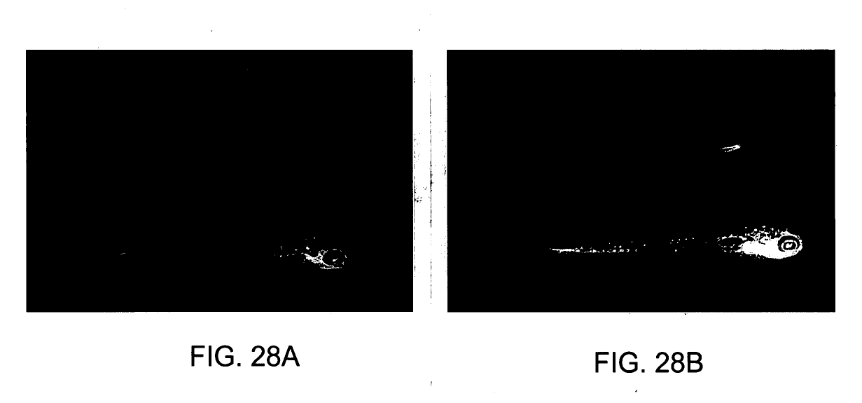

In this example, zebrafish larvae were treated with angiogenesis inhibitors, images were collected using the side-view microwell arrays, and the images were compared to images of untreated zebrafish larvae. The zebrafish used in this example expressed green fluorescent protein (GFP) under control of the fli-1 gene. The head and vasculature of the animals were fluorescent (See FIGS. 28A and B). Improved fluorescence contrast was observed in 6 day post fertilization (dpf) larvae as compared with 4 dpf larvae.

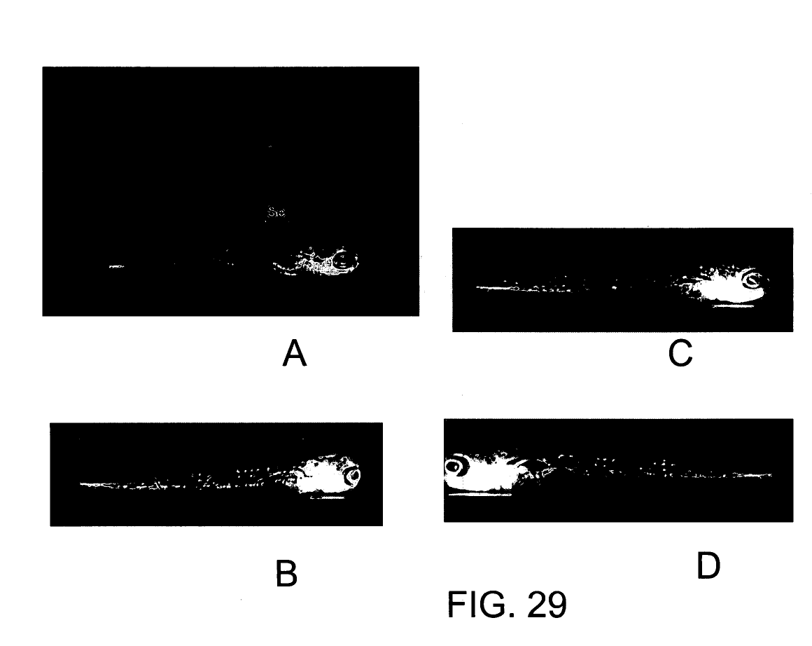

Embryos were loaded into wells at approximately 8 hours post-fertilization (hpf). In some cases angiogenesis inhibitor compounds 676475 or 676480 (Calbiochem) were added immediately after placement of the animals in the wells to a final concentration ranging between 1 μm and 10 μm. The arrays were sealed with a gas permeable adhesive membrane (Aeraseal™, RPI Corp) and were incubated in a humidified chamber until imaging. Image collection was carried out using a Leica DM RB microscope equipped with a 2.5× objective and a Cooke Sensicam QE TE-cooled camera. The intersegmental vessels (Se) were fully extended to the dorsal surface of untreated larvae (FIG. 29A). In the treated larvae, the Se either failed to extend to the dorsal surface of the animal or failed to develop altogether (FIGS. 29B-27D).

While the technology has been particularly shown and described with reference to specific illustrative embodiments, it should be understood that various changes in form and detail may be made without departing from the spirit and scope of the technology.

What is claimed:

1. An apparatus for imaging a sample comprising
a substrate defining a well for holding the sample, the well comprising a bottom and a first wall; and
a first optical surface adjacent the first wall of the well, the first optical surface directing radiation from the well to an imaging lens located below the substrate.

2. The apparatus of claim 1, wherein at least one wall of the well is adapted to orient a bottom surface of the sample adjacent a bottom plane of the well.

3. The apparatus of claim 1, wherein the first optical surface is adjacent two or more wells.

4. The apparatus of claim 1, further comprising a second optical surface adjacent a second wall of the well, the second optical surface adapted to direct incident radiation through said second wall to the sample.

5. The apparatus of claim 4, wherein the second optical surface is adjacent two or more wells.

6. The apparatus of claim 4, wherein the second optical surface directs the incident radiation to a side surface of the sample, and radiation reflected or emitted by the sample is directed to the imaging lens, thereby forming a side image of the sample.

7. The apparatus of claim 4, wherein at least one of the first and second optical surfaces comprises a prism formed in a lower portion of the substrate.

8. The apparatus of claim 1, wherein the first optical surface directs incident radiation traveling along a first optical path to a second, substantially orthogonal optical path to the sample through the wall of the well.

9. The apparatus of claim 1, further comprising an upper portion defining a tapered hole positionable over the well.

10. The apparatus of claim 9, wherein the upper portion comprises a surface adapted to diffuse an incident beam of radiation.

11. The apparatus of claim 1, wherein the sample is selected from the group consisting of an embryonic amphibian, a larval amphibian, an embryonic fish, a larval fish, and an adult fish,

12. The apparatus of claim 1, wherein the well comprises a rectangular cross-section.

13. The apparatus of claim 1, wherein the substrate defines an array of wells.

14. The apparatus of claim 1, wherein a cross section of the well is tapered.

15. The apparatus of claim 1, wherein the bottom of the well defines an area of about 1.5 millimeters wide and about 6 millimeters long.

16. The apparatus of claim 1, wherein the apparatus comprises 96 wells.

17. The apparatus of claim 1, having the dimensions of a standard 96 well microplate.

18. The apparatus of claim 17, wherein the apparatus is formed as a single piece.

19. An apparatus for imaging a sample comprising:
a substrate defining a rectangular well for holding the sample, the well comprising a bottom, a first wall, and a second wall;
a first optical surface adjacent the first wall of the well, the first optical surface receiving incident radiation and directing the incident radiation through the first wall of the well;
a second optical surface adjacent the second wall of the well, the second optical surface receiving radiation from the well and direct the radiation from the well to an imaging lens located below the substrate, and
an upper portion of the substrate defining a tapered hole positionable over the well.

20. An apparatus for imaging a sample comprising:
a substrate defining a well for holding the sample;
means for directing incident radiation to the sample through a wall of the well; and
means for receiving radiation reflected or emitted by the sample to form an image of the sample.

21. The apparatus of claim 20, further comprising an upper portion, the upper portion defining a hole positionable over the well.

22. The apparatus of claim 21, wherein the upper portion comprises a surface adapted to diffuse an incident beam of radiation.

23. A method of imaging a sample comprising depositing a sample into a well of the substrate of claim 1;
directing radiation into the well, and
receiving radiation reflected or emitted by the sample to form an image of the sample.

24. A method of imaging a sample comprising:
providing a substrate defining a well for holding the sample, the well comprising a bottom, a first wall, and a first optical surface, the first optical surface being adjacent the first wall and adapted to direct radiation from the well to an imaging lens located below the substrate;
directing incident radiation into the well, and
receiving radiation reflected or emitted by the sample into the imaging lens to form an image of the sample.

25. The method of claim 24, further comprising directing the incident radiation into the well through a second wall of the well using a second optical surface adjacent the second wall of the well.

26. The method of claim 24, wherein the first optical surface comprises a prism formed in the substrate.

27. The method of claim 24, further comprising facilitating introduction of the sample to the well using an upper portion of the substrate, the upper portion defining a tapered hole positionable over the well.

28. The method of claim 24, wherein at least one wall is adapted to orient a bottom surface of the sample adjacent the bottom of the well.

29. The method of claim 27, wherein the incident radiation comprises a beam of radiation, further comprising diffusing the incident beam of radiation prior to illuminating the sample.

30. The method of claim 24, further comprising acquiring a bright field image of the sample in the well.

31. The method of claim 24, further comprising acquiring a fluorescence image of the sample in the well.

32. The method of claim 24, wherein the incident radiation comprises fluorescence excitation light delivered to the sample through the top of the well.

33. The method of claim 24, wherein the sample is a zebra fish.

34. A method of imaging a sample comprising:
directing incident radiation to a sample in a well of a substrate;
receiving radiation reflected or emitted by the sample through a wall of the well, and
directing the reflected or emitted radiation via an optical surface formed in the substrate to an imaging lens to form an image of the sample.

35. An apparatus for imaging a sample comprising
a substrate defining a well for holding the sample, the well comprising a bottom and a first wall; and
a first channel adjacent the first wall of the well, the first channel capable of receiving a turning optic capable of directing radiation from the well to an imaging lens located below the substrate.
